(19) United States
(12) Patent Application Publication
(10) Pub. No.: US 2023/0331293 A1
(43) Pub. Date: Oct. 19, 2023

(54) ACTUATOR OF A STEERING SYSTEM OF A MOTOR VEHICLE

(71) Applicant: Schaeffler Technologies AG & Co. KG, Herzogenaurach (DE)

(72) Inventors: Tobias Kirchgaessner, Fürth (DE); Sebastian Krueger, Fürth (DE); Mario Arnold, Aurachtal (DE); Christian Doerner, Sugenheim (DE)

(73) Assignee: Schaeffler Technologies AG & Co. KG, Herzogenaurach (DE)

(21) Appl. No.: 18/028,761

(22) PCT Filed: Sep. 7, 2021
(86) PCT No.: PCT/DE2021/100734

§ 371 Date: Mar. 28, 2023

(30) Foreign Application Priority Data
Sep. 29, 2020 (DE) 10 2020 125 364.8
Nov. 17, 2020 (DE) 10 2020 130 257.6

(51) Int. Cl. B62D 5/04; B62D 15/02

(52) U.S. Cl. CPC B62D 5/0445; B62D 15/0225; B62D 5/0469

(57) ABSTRACT

An actuator of a steering system of a motor vehicle, having a connecting rod which is longitudinally movable in a housing along an actuating path between axial stops and which penetrates the housing and is connectable at one end to a toe link for the articulation of wheels, the stops of which are arranged axially one behind the other and face each other axially. The stops and a stopper interacting with the two stops are located inside the housing.

### CROSS-REFERENCE TO RELATED APPLICATIONS

This application is the U.S. National Phase of PCT Application No. PCT/DE2021/100734 filed on Sep. 7, 2021, which claims priority to DE 10 1020 125 364.8 filed on Sep. 29, 2020, and DE 10 2020 130 257.6 filed on Nov. 17, 2020, the entire disclosures of which are incorporated by reference herein.

### TECHNICAL FIELD

The present disclosure relates to an actuator of a steering system of a motor vehicle, in particular a rear-axle steering system.

### BACKGROUND

DE102018129103 A1 discloses a rear-axle steering system having an actuator which is provided with a connecting rod that is longitudinally displaceable in a housing. The connecting rod penetrates the housing and is displaceable along an actuating path between axial stops. The connecting rod is provided at one end with fork heads, which can be connected to toe links for the articulation of wheels. The connecting rod penetrates spacer rings fixed on the housing. An axial actuating path in the one direction of travel is stopped by the one fork head striking against the one spacer ring in an interlocking manner. An axial actuating path in the other direction of travel is stopped by the other fork head striking against the other spacer ring in an interlocking manner. The spacer rings on the housing form stops and the end faces of the fork heads facing the housing form stoppers.

The interlocking stops according to DE102018129103 A1 require additional measures to ensure the full actuating path, which include bellows that enclose the end faces of the fork heads and the spacer rings. The volume of air enclosed by the bellows changes depending on the position of the connecting rod, so it may be necessary to ensure ventilation that reliably prevents the ingress of foreign matter.

### SUMMARY

It was the object of the present disclosure to specify an alternative actuator which, in a simple manner, reliably enables mechanical actuating path delimitation for the connecting rod.

According to the disclosure, this object is achieved by the actuator described herein.

The actuator of a steering system, such as a rear-axle steering system, of a motor vehicle has a connecting rod which is arranged in a housing and can be displaced longitudinally along an actuating path. The housing can be divided transversely—that is, transversely with respect to the connecting rod axis—or longitudinally. A motor can be mounted on the housing which, via a rotation-rotation gear drives a rotation-translation gear, the translational output member of which can be part of the connecting rod. According to an expedient embodiment, an electric motor rotationally drives a screw drive via a belt drive, the spindle of said screw drive which is provided with a thread being actuated in a translational manner, that is to say it is displaced along its spindle axis.

The end of the connecting rod can be provided with screw-on eyelets or fork heads or other connecting elements that can be screwed onto the two ends of the connecting rod, for example. These connecting elements can be connected in an articulated manner to so-called toe links, which articulate the wheels and change their track. The connecting rod itself can be designed in several parts and consist of a plurality of components that are rigidly connected to one another. The connecting rod can comprise a threaded spindle as part of a screw drive. The longitudinally displaceable connecting rod can be mounted in the housing in a manner secured against rotation. For this purpose, the connecting rod can comprise a connecting rod part having a lateral surface which is designed, for example, as a dihedron or as a polygonal profile and is mounted on sliding surfaces on the housing.

The connecting rod can penetrate the housing with its two ends in order to be able to be connected to toe links of the two wheels of an axle. Such actuators can also be referred to as central actuators.

Starting from a neutral position—where both wheels are set for straight-ahead travel—the axial actuating path of the connecting rod is delimited in both axial directions by interlocking stops. The entire actuating path extends from one end position to the other end position of the connecting rod. The connecting rod is arranged to be longitudinally displaceable between these axial stops.

The stops are arranged axially one behind the other and face each other axially. For example, a groove parallel to the longitudinal axis of the connecting rod can be provided in the housing or in the connecting rod, the axial end groove walls of which can form the stops.

Furthermore, a stopper which interacts with the two stops is provided. The stopper can be designed, for example, in the form of a pin and be arranged transversely with respect to the connecting rod axis and engage between the two stops. The stops facing each other can advantageously be hit by a common stopper and reduce the number of components for delimiting the actuating path. When the connecting rod is moved axially in one direction, the stopper strikes against one of the stops at the end of the actuating path. If the connecting rod is moved axially in the other direction, the stopper strikes against the other stop at the end of the actuating path. Alternatively, the stopper can be formed from two spatially separate stopper parts, one of which is associated with one stop and the other of which is associated with the other stop.

Both the stops and the stopper are arranged within the housing and are thus protected from foreign matter that is outside the housing. These actuators are disposed with their housings on the underside of the vehicle and are therefore exposed to environmental effects. The arrangement within the housing reliably ensures that foreign matter cannot get between the stops and the stopper and that the connecting rod can be reliably moved over its intended actuating path.

The connecting rod can have a threaded spindle on a screw drive—such as a planetary roller screw drive—and a connecting rod part which is non-rotatably connected to the threaded spindle and is provided with the stopper that can engage between the two stops on the housing. As an alternative to this, the connecting rod part can be provided with the stops between which the stopper on the housing engages.

The use of a planetary roller screw drive is particularly favorable because such screw drives do not jam when the connecting rod moves against one of the stops in an interlocking manner. This connecting rod part can also be configured as an anti-rotation device for the connecting rod in the housing, as has already been described above.

The housing can have a housing opening that is covered by a cover. Axially opposite sides of the housing opening can be provided with the stops for the stopper. The wall of the housing opening itself can be used as a stop. However, it may be expedient to insert a separate stop part in the housing opening. Depending on the vehicle type, the desired actuating path can vary. The stop parts provide the advantage that they can be adapted to the desired actuating path with the housing opening unchanged. Alternatively, it is possible for the cover to be provided with the stops engaging in the housing opening. For example, the cover can have a rim that engages in the housing opening and forms the stops in both directions of travel.

The actuator can be provided with a linear displacement sensor for detecting an axial position of the connecting rod, the signal transmitter of which is arranged on a connecting rod part of the connecting rod and the signal receiver of which, covering the actuating path, is associated with the housing. A non-contact linear displacement sensor with an electrically conductive signal transmitter, which forms the stopper, can be provided in a favorable manner. Capacitive linear displacement sensors are particularly favorable. For example, the signal transmitter can be formed from a coated or uncoated steel or aluminum, as can be provided in a capacitive linear displacement sensor. In this case, a component can have a dual function, on the one hand as a signal transmitter of a linear displacement sensor, and on the other hand as a stopper of a mechanical stop for delimiting the actuating path.

### BRIEF DESCRIPTION OF THE DRAWINGS

The disclosure is explained in more detail below with reference to two exemplary embodiments shown in five figures altogether. In the drawings:

FIG. 1 shows an actuator in one view;

FIG. 2 shows a detail of the actuator from FIG. 1 in a longitudinal sectional view;

FIG. 3 shows an enlargement of the detail from FIG. 2;

FIG. 4 shows a variant of the actuator in an enlarged detail view as in FIG. 3;

FIG. 5 shows a cross-sectional view of the detail of the actuator from FIG. 2.

### DETAILED DESCRIPTION

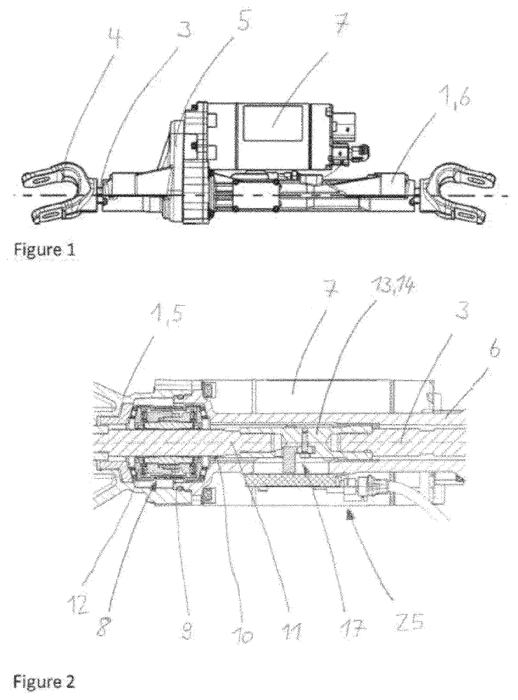

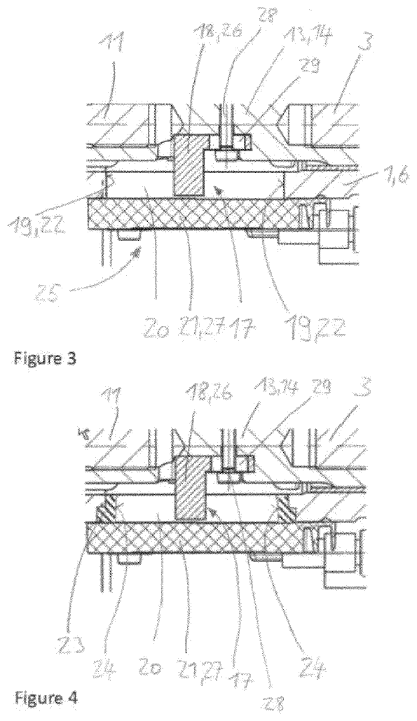

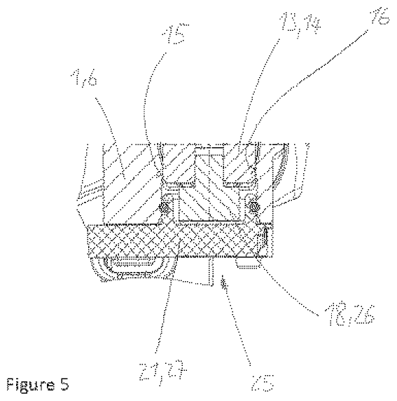

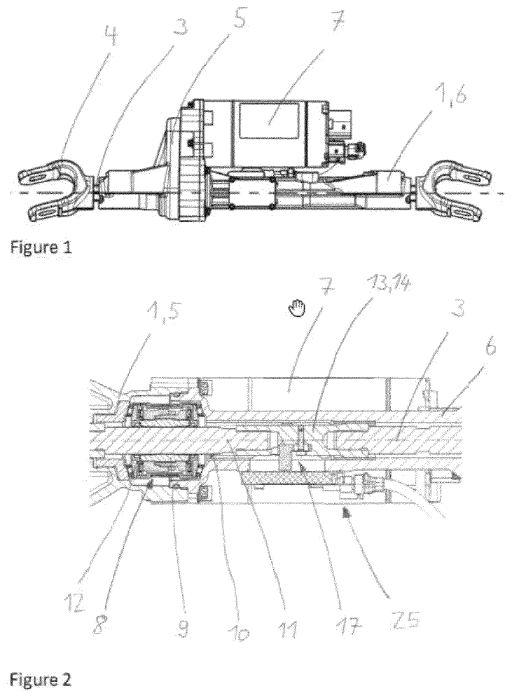

FIGS. 1 and 2 show an actuator of a rear-axle steering system of a motor vehicle, comprising a multi-part connecting rod 3 which is arranged in a housing 1 in a manner longitudinally displaceable along an actuating path and which penetrates the housing 1 and is provided at the end with fork heads 4 which are screwed to the ends of the connecting rod 3. The fork heads 4 are connected to toe links, not shown, which in turn articulate wheels, not shown, of the rear axle. Such actuators can also be referred to as central actuators.

The housing 1 is divided into two housing parts 5, 6 transversely with respect to the connecting rod axis. An electric motor 7 is screwed to the housing 1 and drives a planetary roller screw drive 8 (rotation-translation gear) via a toothed belt drive (rotation-rotation gear), not shown, the planetary rollers 9 of said planetary roller screw drive meshing with a thread 10 of a threaded spindle 11, which is part of the connecting rod 3. Under the rotary drive of a planetary roller carrier 12, the planetary rollers 9 rotate about their axes and around the non-rotatable threaded spindle 11. A full revolution of the planetary roller carrier 12 forces an axial advancement of the connecting rod 3 by the amount of the pitch of the thread 10 of the threaded spindle 11.

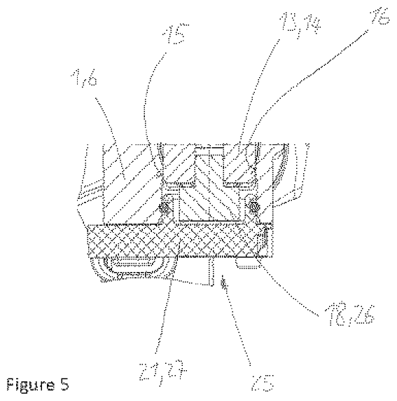

The connecting rod 3 is composed of a plurality of components that are rigidly connected to one another. It comprises the threaded spindle 11 and further connecting rod parts, of which the first connecting rod part 13 screwed together with the threaded spindle 11 is designed as an anti-rotation device 14 of the connecting rod 3. This anti-rotation device 14 has a dihedron 15 which is mounted on counter surfaces 16 on the housing (FIG. 5).

Starting from the neutral position shown in FIG. 1—where both wheels are set for straight-ahead travel—the axial actuating path of the connecting rod 3 is interlockingly delimited in both axial directions by an actuating path delimiter 17.

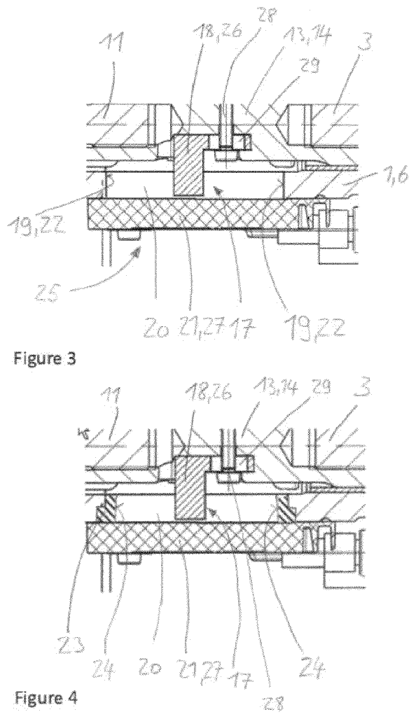

FIG. 3 shows a detail of the actuating path delimiter 17, which has a pin-like stopper 18 which is screwed to the anti-rotation device 14. The stopper 18 engages between two stops 19 on the housing which are arranged axially one behind the other and face each other. When the connecting rod 3 is moved axially in one direction, the stopper 18 strikes against one of the stops 19 at the end of the actuating path. When the connecting rod is moved axially in the other direction, the stopper 18 strikes against the other stop 19 at the end of the actuating path.

The housing 1 has a housing opening 20 which is covered by a cover 21. Housing walls 22 of the housing opening 20 lying axially opposite one another form the stops 19 in this exemplary embodiment.

FIG. 4 shows a variant with inserts 23, which are inserted in the housing opening 20 and form stops 24 between which the stopper 18 can move. The axial extension of the inserts 23 is matched to the desired actuating path.

The actuator is provided with a non-contact linear displacement sensor 25, specifically with a capacitive linear displacement sensor 25 for detecting an axial position of the connecting rod 3. An electrically conductive signal transmitter 26—also referred to as a target—is screwed onto the anti-rotation device 14 of the connecting rod 3. The cover 21 includes a signal receiver 27, which is provided with a large number of coils, not shown in any further detail, and which extends over the length of the actuating path of the connecting rod 3.

In the exemplary embodiment, the stopper 18 is formed by the pin-like signal transmitter 26. This component therefore has a dual function, on the one hand functioning as a signal transmitter for the linear displacement sensor and on the other hand functioning as a stopper for the actuating path delimiter. For calibration purposes, the signal receiver 27, which is screwed tight with a screw 28, is provided with an elongated hole 29, such that when the screw 28 is loosened, the signal receiver 27 can be displaced axially on the anti-rotation device 14 for calibration.

### LIST OF REFERENCE SYMBOLS

1 Housing
3 Connecting rod
4 Fork head
5 Housing part
6 Housing part
7 Electric motor
8 Planetary roller screw drive
9 Planetary roller
10 Thread
11 Threaded spindle
12 Planetary roller carrier
13 First connecting rod part
14 Anti-rotation device
15 Dihedron
16 Counter surfaces
17 Actuating path delimiter
18 Stopper
19 Stop
20 Housing opening
21 Cover
22 Housing wall
23 Insert
24 Stop
25 Linear displacement sensor
26 Signal transmitter
27 Signal receiver
28 Screw
29 Elongated hole

1. An actuator of a steering system of a motor vehicle, the actuator comprising a connecting rod longitudinally movable in a housing along an actuating path between two axial stops, the connecting rod penetrating the housing and configured for articulation of wheels, and the two axial stops are arranged axially behind one another and facing each other axially, and a stopper interacting with the two axial stops is located inside the housing.

2. The actuator according to claim 1, wherein the connecting rod includes:
a threaded spindle of a screw drive, and
a first connecting rod part non-rotatably connected to the threaded spindle, the first connecting rod part having the stopper engaging between the two axial stops arranged on the housing.

3. The actuator according to claim 1, wherein the connecting rod includes:
a threaded spindle of a screw drive, and
a first connecting rod part non-rotatably connected to the threaded spindle, and
the first connecting rod part provided with the stopper.

4. The actuator according to claim 2, wherein the first connecting rod part is configured as an anti-rotation device for the connecting rod.

5. The actuator according to claim 2, wherein the housing further comprises a housing opening covered by a cover, the housing opening provided on its axially opposite sides with the two axial stops.

6. The actuator according to claim 5, wherein the two axial stops are formed on at least one insert inserted in the housing opening.

7. The actuator according to claim 5, wherein the cover is provided with the two axial stops.

8. The actuator according to claim 2, further comprising a linear displacement sensor configured for detecting an axial position of the connecting rod, and a signal transmitter of the linear displacement sensor is arranged on the connecting rod and a signal receiver of the linear displacement sensor, covering the actuating path, is associated with the housing.

9. The actuator according to claim 8, wherein the linear displacement sensor is a non-contact linear displacement sensor, and includes an electrically conductive signal transmitter configured to form the stopper.

10. The actuator according to claim 1, further comprising:
a screw drive,
a motor configured to drive the screw drive, and
a threaded spindle non-rotatably arranged within the housing, the threaded spindle to move axially within the housing.

11. The actuator according to claim 1, wherein the stopper is configured as a signal transmitter for a linear displacement sensor.

12. An actuator for a steering system of a motor vehicle, the actuator comprising:
a housing having two axial stops, the two axial stops facing each other,
a connecting rod longitudinally movable within the housing along an actuating path defined by the two axial stops, and longitudinal movement of the connecting rod is configured to move at least one wheel of the motor vehicle,
a stopper mounted on the connecting rod, the stopper configured to abut with each of the two axial stops.

13. The actuator according to claim 12, wherein the connecting rod is configured as part of a screw drive.

14. The actuator according to claim 12, wherein the connecting rod is configured as part of a planetary roller screw drive.

15. The actuator according to claim 12, wherein the connecting rod is configured to non-rotatably engage the housing such that rotation of the connecting rod relative to the housing is prevented.

16. The actuator according to claim 12, wherein the stopper is configured to be axially adjustably mounted to the connecting rod.

17. The actuator according to claim 12, wherein the stopper is configured as a signal transmitter for a linear displacement sensor.

18. The actuator according to claim 17, wherein the stopper moves axially within an opening of the housing, and a cover for the opening is configured as a signal receiver for the linear displacement sensor.

19. An actuator for a steering system of a motor vehicle, the actuator comprising:
a housing,
a connecting rod longitudinally movable within the housing along an actuating path defined by two axial stops arranged axially behind one another and facing each other axially, and longitudinal movement of the connecting rod is configured to move at least one wheel of the motor vehicle,
a linear displacement sensor arranged within the housing, the linear displacement sensor configured for detecting an axial position of the connecting rod, the linear displacement sensor having:
a signal transmitter arranged within the housing, the signal transmitter configured to abut with each of the two axial stops such that the signal transmitter and a first of the two axial stops define a first end of the actuating path and the signal transmitter and a second of the two axial stops define a second end of the actuating path, and
a signal receiver arranged within the housing, the signal receiver configured to cooperate with the signal transmitter to detect the axial position of the connecting rod within the actuating path, the signal receiver arranged within the housing.

20. The actuator according to claim 19, further comprising a planetary roller screw drive configured to cooperate with threads of the connecting rod to move the connecting rod along the actuating path.
